(19) United States
(12) Patent Application Publication
(10) Pub. No.: US 2004/0171346 A1
(43) Pub. Date: Sep. 2, 2004

(54) Method of Adding Wireless Remote Control to Audio Playback Devices Equipped for Wired Remote Control

(75) Inventor: Mr. John Lin, Los Angeles, CA (US)

Correspondence Address: JEFFERS, MANGELS, BUTLER & MARMARO, LLP, 1900 AVENUE OF THE STARS, 7TH FLOOR, LOS ANGELES, CA, 90067

(73) Assignee: Ten Ventures Inc., Los Angeles (US)

(21) Appl. No.: 10/752,247

(22) Filed: Jan. 5, 2004

Related U.S. Application Data
(60) Provisional application No. 60/462,663, filed on Apr. 14, 2003.

(51) Int. Cl. H04H 1/00

(52) U.S. Cl. 455/3.05

(57) ABSTRACT

### Abstract of the Disclosure

A method for providing wireless remote control capability to an audio playback device equipped with wired control capability is described. The method includes the steps of receiving a wireless signal in a base station coupled to the audio playback device; decoding the wireless signal; and, generating a command compatible with the audio playback device based on the wireless signal. An apparatus for implementing the method is also described.

### Detailed Description of the Invention

### Background of Invention

Field of the Invention

The present invention relates generally to remote control devices for electronic devices, and more particularly, to a method and apparatus for enabling the wireless control of audio playback devices that previously were only equipped for wired remote control.

Background of the Invention

The recent rise of portable digital audio players with large storage capabilities, such as sthe iPOD (TM) audio player made by Apple Computer, Inc., has made it possible to carry entire music collections in one"s pocket. With the addition of a set of powered speakers, such an audio player can serve as a complete sound system for a room or office. However, since these audio players are designed primarily to be used with headphones and with pocket portability in mind, various extra features, such as wireless remote control, were not implemented. In contrast, the ability to interface a wired remote control is often implemented so that the audio playback can be controlled while the main unit is safely hidden inside a pocket or bag.

One problem with having a wired remote control is that the wired remote control requires a user to be physically next to the audio player. The user is not allowed to leave the audio player in one location and move, for example, across the room beyond the distance of the length of the wired remote control cable and still control the audio player.

### Summary of Invention

The present invention provides a method for providing wireless remote control capability to an audio playback device equipped with wired control capability. In one embodiment, the method includes the steps of receiving a wireless signal in a base station coupled to the audio playback device; decoding the wireless signal; and, generating a command compatible with the audio playback device based on the wireless signal.

The present invention also provides an apparatus for adding wireless remote control to an audio playback device configured to receive a wired controller. The apparatus including a receiver, the receiver configured to receive a wireless communication; a processing circuit coupled to the receiver, the processing circuit configured to translate the received wireless communication into a command understood by the audio playback device; and, a connector configured to couple the circuit to the audio playback device.

### Brief Description of Drawings

The invention may be more readily understood by referring to the accompanying drawings in which:

FIG. 1 illustrates a remote control unit and a base station configured in accordance to one embodiment of the present invention.

FIG. 2 illustrates the connection of an audio player to the base station in accordance with one embodiment of the present invention.

FIG. 3 illustrates the base station and audio player once the audio player has been fully connected to the base station in accordance with one embodiment of the present invention.

FIG. 4 illustrates a wireless transmission from the remote control unit to the base station in accordance with one embodiment of the present invention.

FIG. 5 is an internal view of the base station configured in accordance with one embodiment of the present invention.

FIG. 6 illustrates the ports for connecting the power and audio cables located on the base station in accordance with one embodiment of the present invention.

FIG. 7 illustrates the base station and audio player after the power and audio cables, and the audio player have been connected to the base station in accordance with one embodiment of the present invention.

FIG. 8 is a block diagram illustrating how the remote control unit, base station, and audio player interact with each other when a button is pressed on the remote control unit in accordance with one embodiment of the present invention.

FIG. 9 is a flow diagram illustrating the operation of the base station in accordance with one embodiment of the present invention.

FIG. 10 illustrates a remote control unit and base station configured in accordance with another embodiment of the present invention.

FIG. 11 illustrates an audio playback device docked into the base station of FIG. 10.

FIG. 12 illustrates an integrated base station stand deployed to support the connected base station and audio playback device of FIG. 11.

FIG. 13 illustrates the operation of the remote control unit and the base station of FIG. 10 in accordance with one embodiment of the present invention.

FIG. 14 illustrates the major components of the base station and remote control unit of FIG. 10, including a set of antennas configured in accordance with one embodiment of the present invention.

FIG. 15 illustrates the connection of an audio output cable to the remote control unit of FIG. 10.

FIG. 16 illustrates the connection of a data/power cable to the base station of FIG. 10.

FIGs. 17 and 18 illustrate the docking of the audio playback device to the base station of FIG. 10 in accordance with one embodiment of the present invention.

FIGs. 19-21 illustrate the operation of the wireless remote control system of FIG. 10.

Like numerals refer to like parts throughout the several views of the drawings.

### Detailed Description

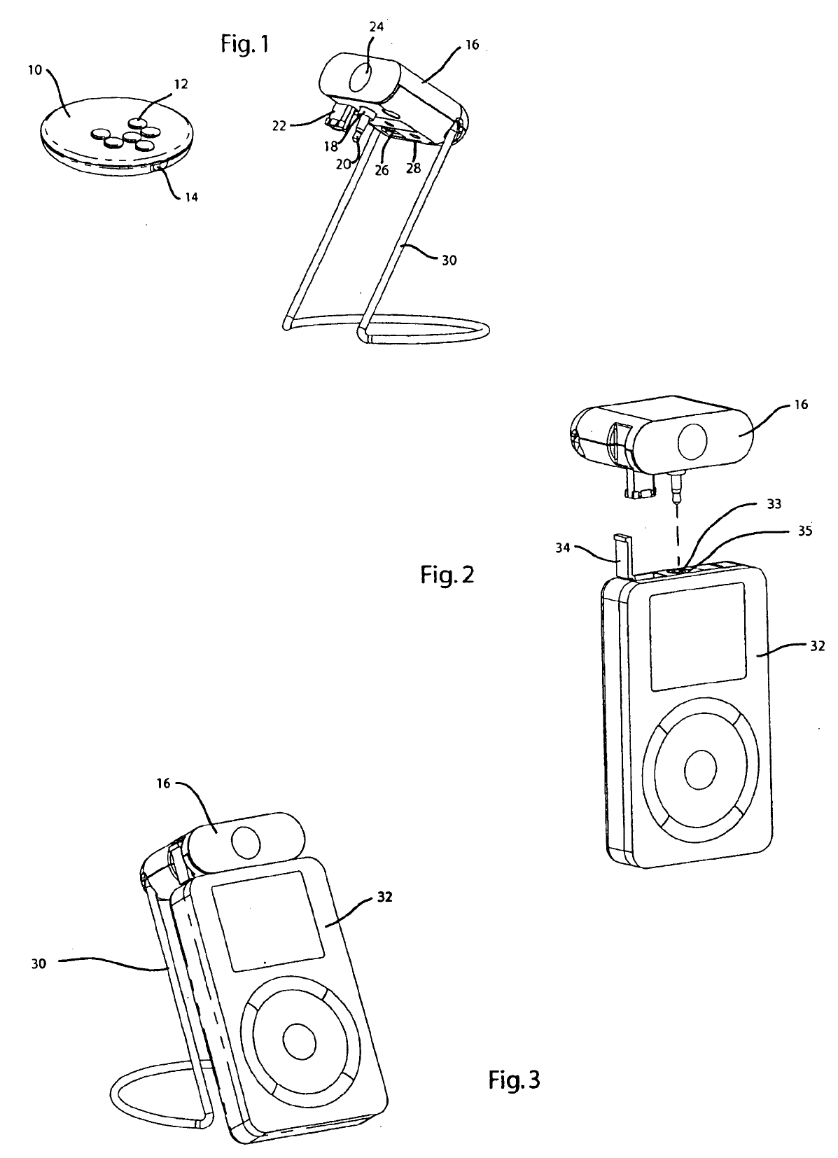

FIGs. 1 and 3 illustrate a wireless remote control system 2 for providing wireless remote control for an audio playback device 32 with a wired remote control. Wireless remote control system 2 includes a remote control unit 10 with buttons 12 for commands such as play, pause, skip forward, skip back, volume up and volume down; and a base station 16 mounted on a removable stand 30. In one preferred embodiment, stand 30 is configured as a bracket with a semicircular base and props up audio playback device 32 such that a display on audio playback device 32 may be seen. Stand 30 is also configured to be a cable management device, as described further below. In addition, stand 30 may take another form, such as a cradle, to support audio playback device 32. In some cases, stand 30 may be eliminated.

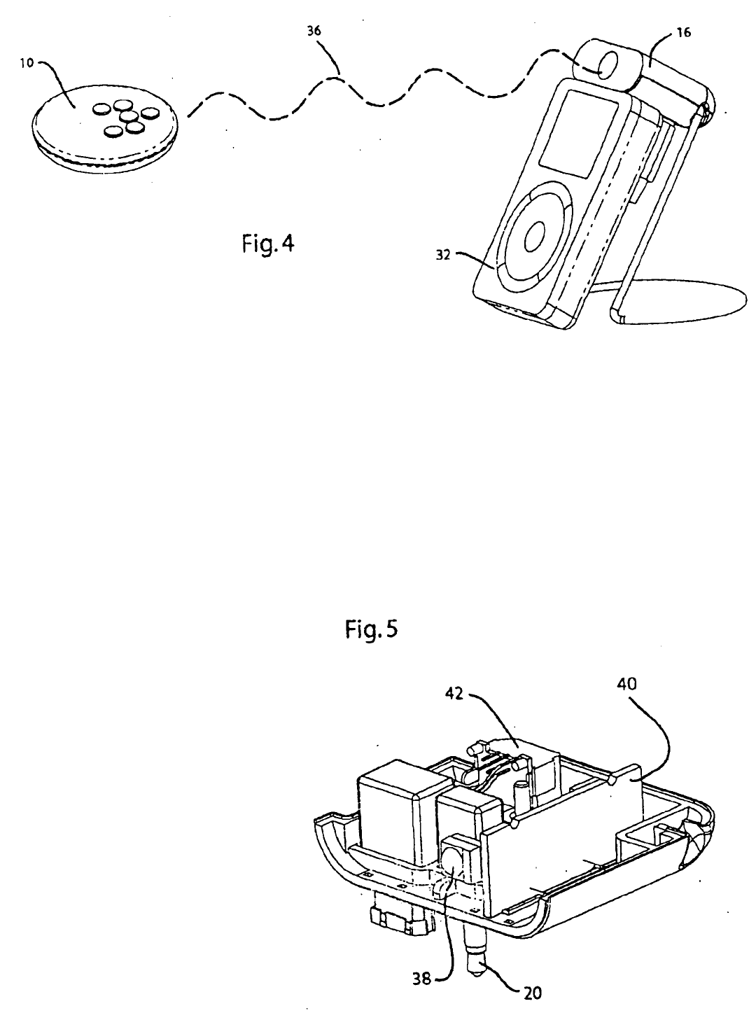

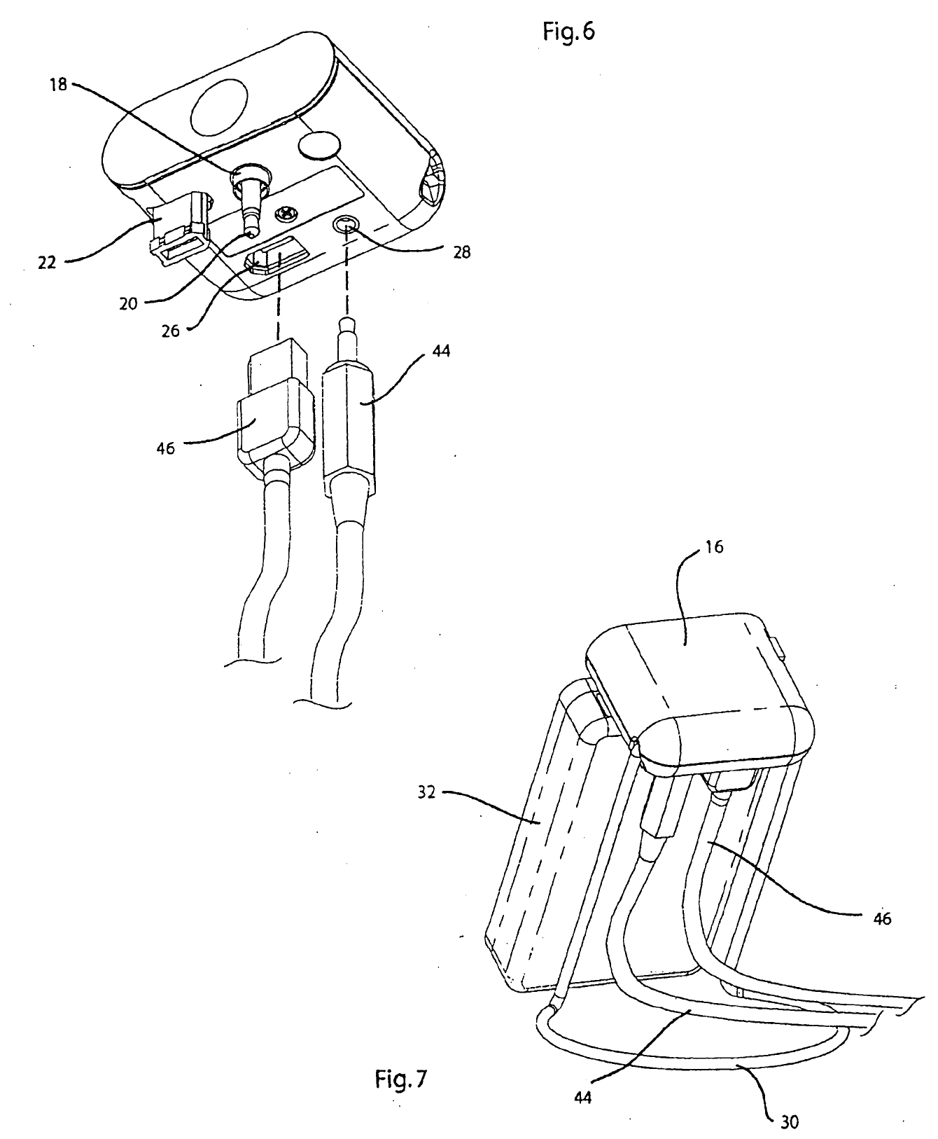

In one preferred embodiment, as shown by FIG. 4, remote control unit 10 communicates wirelessly with base station 16 through an infrared (IR) light emitting diode (LED) 14. Base station 16 receives the commands from the remote control unit 10 using an IR detector 38 (shown in FIG. 5) that is located behind an IR transparent window 24 in base station 16.

FIG. 5 is an internal component view of base station 16 configured in accordance with one embodiment of the present invention that includes a power feedthrough connector assembly 42 and an electronic circuit assembly 40, including IR detector 38. Referring also to FIG. 2, in one preferred embodiment, base station 16 is configured with several plugs to interface with audio playback device 32, including a remote connector plug 18 for connecting base station 16 to a wired remote jack 35 of audio playback device 32 to access a wired remote interface of audio playback device 32. Further, a stereo audio plug 20 plugs into a headphone jack 33 of audio playback device 32, and a power feed-through connector 22 plugs into a power connector 34 of audio playback device 32.

As shown in FIG. 6, base station 16 is also configured with an audio output jack 28 to connect to an audio cable 44 to output the sound from audio playback device 32 on such audio output devices as powered speakers or a sound system. Base station 16 also includes a power input receptacle 26 for receiving a power supply cable 46 to receive power for base station 16 and audio playback device 32.

To set-up wireless remote control system 2, base station 16 is plugged into audio playback device 32, as shown in FIG. 2. In one preferred embodiment, power feedthrough plug 22 is compliant to allow for variations in connector spacing on audio playback device 32. Furthermore, a notch in shell of the base station 16 allows clearance for the power input receptacle door 34. Then, audio cable 44, which connects either powered speakers (not shown) or a sound system (not shown), can have been previously or be subsequently connected to audio output jack 28 of base station 16. When base station 16 is plugged into audio playback device 32, base station 16 is able to draw power from the wired remote jack 35 on the audio playback device 32. As a result, powering the base station separately is not necessary. However, as discussed above, power cable 46 from an external power source may be plugged into power input receptacle 26 of base station 16, which will pass the power through the power feedthrough connector assembly 42, out the power feedthrough plug 22, and into power receptacle 34 of audio playback device 32. This allows audio playback device 32 to be charged while base station 16 is connected.

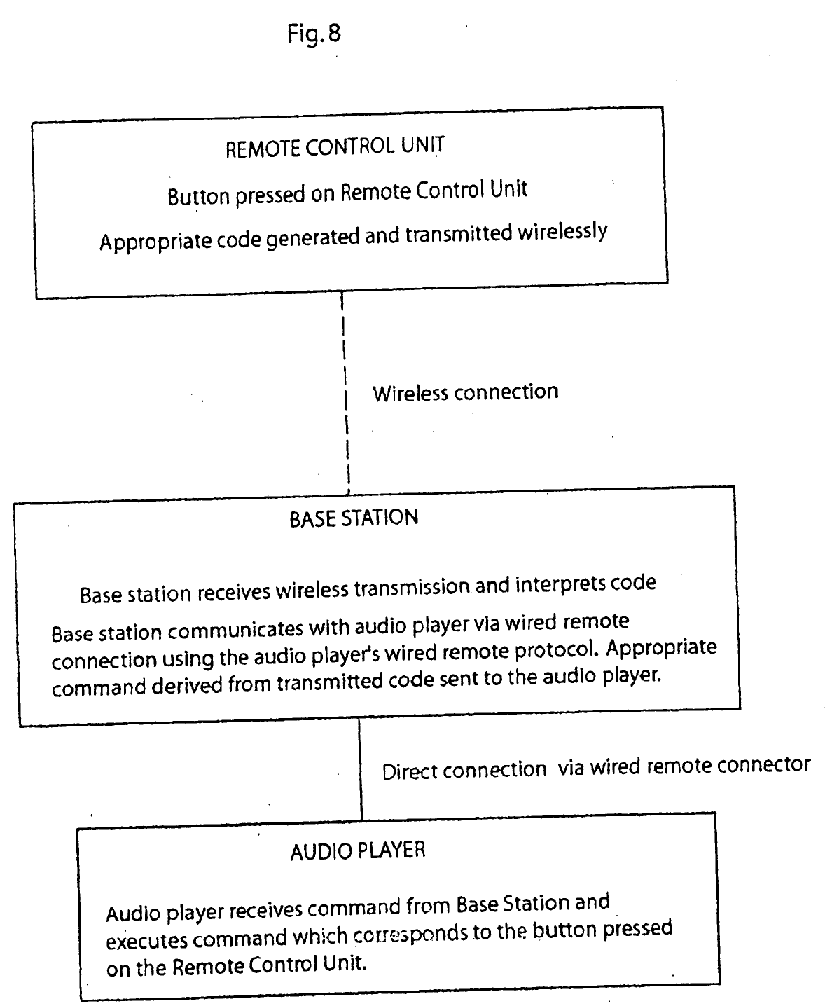

As illustrated in FIGs. 4 and 8, remote control unit 10 sends different wireless signals 36 to base station 16 in response to the different buttons selected from buttons 12 on remote control unit 10. Remote control unit 10 continuously sends signals as long as a button is depressed. Once base station 16 receives the signals sent from remote control unit 10, a microprocessor on circuit board 40 in base station 16 converts these wireless protocol commands to the appropriate wired remote commands native to audio playback device 32. This allows the user to wirelessly control audio playback device 32 using the same commands available to a wired remote of audio playback device 32. Effectively, base station 16 emulates a wire remote attached to the audio playback device 32.

It should be noted that there are many alternate ways to implement wireless control using the wired remote interface of audio playback device 32. For example, while the above-described embodiment utilized IR wireless communication between the remote control unit 10 and base station 16, other wireless communication schemes could be used, including radio frequency signaling, ultrasonic signaling, or digital radio frequency signaling. Signaling standards that may be used include, but is not limited to such standards as the Bluetooth standard, as described at the world-wide web site of the Bluetooth special interest group at http://www.bluetooth.org, or the various versions of the wireless Ethernet standard, also known as "WiFi,"as promulgated by the Institute of Electrical and Electronic Engineers (IEEE) 802.11.

As discussed above, base station 16 can provide power to audio playback device 32 by passing through the power it receives from power cable 46. In another embodiment, power does not need to be passed through base station 16 for charging audio playback device 32.

Depending on the configuration of audio playback device 32, audio output from audio playback device 32 does not need to pass through base station 16. If audio output jack 33 of audio playback device 32 is far enough away from the wired remote jack 35, speaker audio cable 44 could plug directly into audio output jack 33 while base station 16 is plugged into wired remote jack 35. In the simplest case, base station 16 only connects to wired remote jack 35 with neither power nor audio output feedthrough.

Buttons 12 on remote control unit 10 are not limited to being the same as those on the wired remote. With appropriate programming of the microprocessor of base station 16, additional buttons could be implemented, such as an auto skip that skips to the next track every few seconds, or a mute command. Alternatively, buttons could also be removed for simplification.

Appropriate selection of protocols will prevent accidental activation of other unrelated remote control devices. The electrical circuits and communication protocols used for wireless IR communication between remote control unit 10 and base station 16 are well-known to those skilled in the art of IR remote controls.

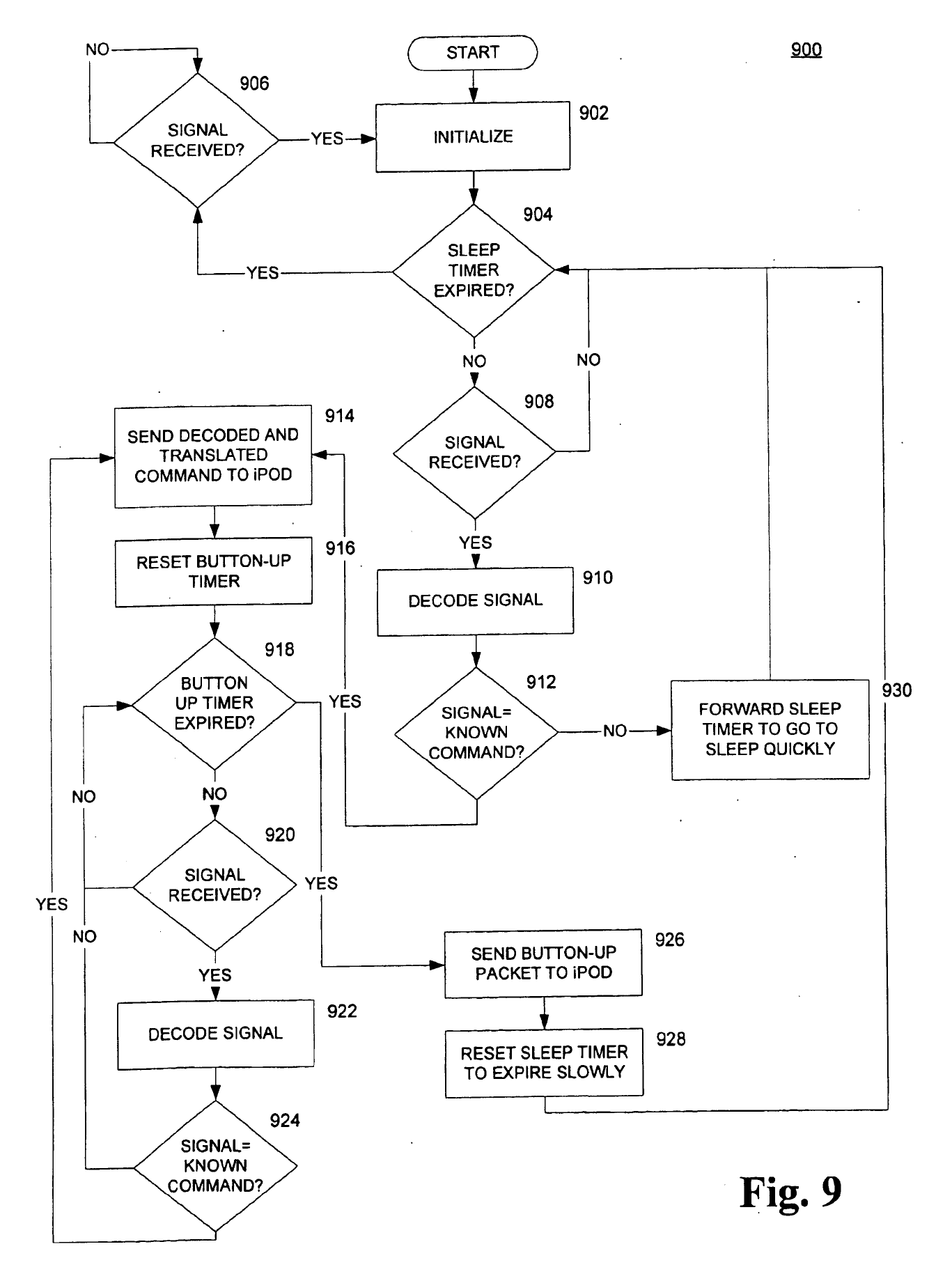

FIG. 9 is a flow chart illustrating the operation of remote control unit 10 and base station 16 as controlled by the operating software contained in base station 16 in accordance with one embodiment of the present invention. Starting with step 102, where wireless remote control system 2 initializes. Operation then proceeds with step 904, where it is determined if a sleep timer maintained by the system has expired. Specifically, it is determined if a period of inactivity has been reached for base station 16 to "sleep" or power down. As described further below, the sleep timer may be set to one of two durations, a short duration, and a long duration. As wireless remote control system 2 has just been initialized, the sleep timer should not be expired, so operation continues with step 908.

In step 908, base station 16 determines if IR detector 38 has received a signal from remote control unit 10. If so, then operation goes to step 910, where base station 16 decodes the received signal. In one embodiment, base station 16 decodes the signal into a series of pulses, which is then converted into a series of binary digits that may be interpreted by the microprocessor in base station l6. In other embodiments, base station 16 may function with other wireless signals such as radio frequency or electromagnetic waves, converting them into either an analog or a digital electrical signal that may be interpreted by the microprocessor in base station 16.

Once the received signal is decoded, operation then continues with step 912, where the decoded signal is compared by base station 16 to "known" commands, which are commands that are understood by audio playback device 32, an example of which includes the iPOD (TM) audio playback device from Apple Computer, Inc. If the received and decoded signal matches a known command, operation continues with step 914. Otherwise, operation continues with step 930.

In step 930, when base station 16 has determined that the received and decoded signal does not match a known command, base station 16 will adjust the sleep timer to decrease the amount of time before base station 16 enters into sleep mode. In another embodiment, the sleep timer is immediately set to the sleep value if an unknown command is received. After the value in the sleep timer has been adjusted in step 930, operation returns to block 904, as described below.

Returning to step 914, once it has been determined by base station 16 that the received and decoded signal is a known command, base station 16 will transmit the command to audio playback device 32 by base station 16 through wired remote jack 35. Thus, in operation, base station 16 will first receive a wireless signal and then decode/translate the signal to an audio playback device command that is understood by audio playback device 32. As a result, the existing commands understood by audio playback device 32 may be used by base station 16 without change. In another embodiment, base station 16 may also be programmed with additional commands such that base station 16 may generate multiple commands to audio playback device 32 based on the receipt of a single wireless signal. For example, remote control unit 10 may include a "skip ten seconds" button that, when pressed, will generate a wireless signal to base station 16 signaling the base station that a skip ten second button has been pressed. Base station 16, in turn, will generate commands as appropriate to forward the playback of the file by ten seconds--such as simulating a user pressing on the fast forward button for ten seconds. In other embodiments, different combinations, sequences and timing of commands understood by audio player 32 may be generated by base station 16.

In step 916, base station 16 resets a button-up timer. The button-up timer, in one embodiment, is a countdown timer that is reset to the same value every time base station 16 receives an IR button packet. Once the button-up timer is reset, it is then decremented until it reaches zero unless base station 16 receives another IR button packet. In other embodiments, the button-up timer may be a value that is incremented or decremented by a certain amount based on a unit time until it reaches a particular value unless base station 16 receives another IR button packet. In yet another embodiment, the button-up timer may be set to and then changed by different amounts based on the type of command sent in the received IR button packet. For example, the button-up timer may be set to a smaller value if a "stop" button packet is received, indicating that the user wishes to stop playback of the current selection. As it is unlikely that the user would send two presses of the stop button or continuously hold down the stop button, base station 16 may exit the loop comprised of steps 918, 920, 922 and 924 much more quickly.

In step 918, base station 16 determines if the button-up timer has expired. As remote control unit 10 continuously generates IR button packets while a button is being depressed, if the button-up timer expires then base station 16 assumes that all the buttons on remote control unit 10 have been inactive. In other words, the button-up timer expires only when the user is not depressing any buttons on remote control unit 10 as a result from base station 16 not having received any valid IR command packets to reset the button-up timer in step 916.

If the button-up timer has not expired, operation continues with step 920, where base station 16 determines if an IR signal has been received. If so, operation continues with step 922, where the signal is decoded. Then, in step 924, base station 16 determines if the received and decoded signal is a known command. If no valid signal is received in step 920, or, if the received signal does not decode into a known command in step 924, then operation returns to step 918. If the signal received is a known command in step 924, operation returns to step 914. In one embodiment, the operations performed by base station 16 in steps 920, 922, and 924 are the operations as described in steps 908, 910, and 920, respectively.

Returning to step 918, if the button up timer has expired, operation continues with step 926, where base station 16 sends a button-up packet to audio playback device 32. Then, operation continues with step 928, where base station 16 sets the sleep timer to the long sleep timer duration, which will delay base station 16 from entering into the sleep mode for a longer period of time, as discussed herein.

In the embodiment as described in the flow chart on FIG. 9 at steps 918, 920, 922 and 924, as long as the user continuously presses a button on remote control unit 10, it will repeatedly send IR signals/commands such that: (1) button-up timer will continuously be reset and consequently will not be allowed to expire; (2) the signal received by base station 16 would decode to the same command as the last command as the button is still be depressed; and, (3) that command would be transmitted to audio playback device 32 in step 914.Thus, audio playback device 32 would receive the same command repeatedly until the user releases the button. In other words, audio playback device 32 would receive repeated command packets followed by a terminate packet. The period of time between each transmission of an IR signal from remote control unit 10 while a button is depressed is referred to as an IR packet period.

Returning to step 904, when base station 16 determines that the sleep timer has expired, base station 16 will enter into a power conservation, or "sleep" mode. In another embodiment, multiple timers and power saving modes may be used by bay station 16 to conserve the most power. In step 906, base station 16 will continuously wait for a signal to be received to "awaken" base station 16 from sleep. If so, base station 16 will return to step 902 where the system will initialize as previously discussed.

Base station 16 may have multiple power conservation or sleep modes ranging from where base station 16 enters into a complete power down mode, where all electronic circuitry is powered down, to a mode where only portions of electronics of base station 16 are still operational. In one embodiment, the power conservation mode includes powering down all circuits in base station 16 that are not used in the receipt and decoding of IR signals. Further, when base station 16 enters into a power saving mode it may also send a command to audio playback device 32 to cause the device to power down. Other modes of power conservation of either base station 16 or audio playback device 32 may be contemplated. Thus, base station 16 may be in a different power conservation mode (from no power conservation to fully powered down) as compared to audio playback device 32, although it is preferred that base station 16 be at a power conservation mode that is one level less than audio playback 32 to provide control of audio playback 32. For example, audio playback device 32 may be in a partially powered down mode such that only such critical functions as playback and audio signal generation-but not display or backlighting, are available, but base station 16 may be at a fully-powered mode to receive wireless signals and generate commands which will activate audio playback device 32 into a mode of operation in which audio playback device 32 was operating before audio playback device 32 entered into the partially powered down mode.

In one embodiment of the present invention, the sleep timer may be set to two durations: (1) a short duration if base station 16 is awakened from sleep by a received signal using IR detector 38, as seen in the sequence of steps 906, 902, 904, 908, 910, 912, and 930; and (2) a longer duration if base station 16 is actively being used, as seen in the sequence of steps 918, 926, and 928. In one embodiment, the short duration is approximately 230.4 milliseconds (ms) while the longer duration is approximately 3.76 seconds. The shorter duration provides for base station 16 returning to a sleep mode sooner if it is awoken by noise and not an actual valid signal. In one embodiment, the short duration of the sleep timer is set to be greater than 200 percent of the IR packet period to provide some forgiveness to the system. By allowing base station 16 to receive two IR packets before going to sleep, base station 16 can still misinterpret the first IR packet as noise and still have an opportunity to correctly interpret the second packet before going to sleep.

An implementation of the sleep timer in accordance with one embodiment of the present invention is described as follows. The sleep timer operates using two countersa short counter and a long counter. The short counter increments every 256 microseconds (μs) and expires every 75*256μs, or 19.2ms. The long counter decrements every time the short counter expires. The short duration corresponds to 12 long counter periods (230.4ms = 12*(75*256μs)), while the longer duration corresponds to 196 long counter periods (3.76s = 196*(75*256μs)). In other embodiments, the sleep timer may be incremented or decremented at different rates depending on whether base station 16 should be placed to sleep slowly or more quickly. Thus, the increment or decrement of sleep timer per unit time may be altered. Further, one or more counters or timers may be used.

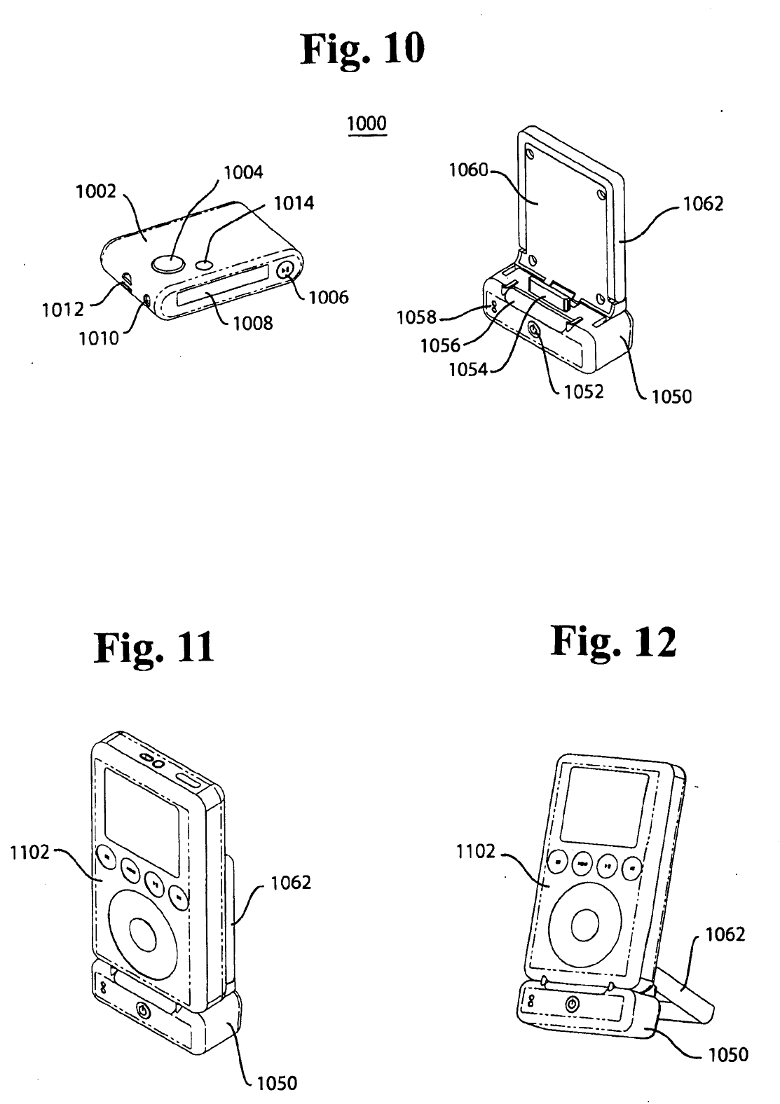

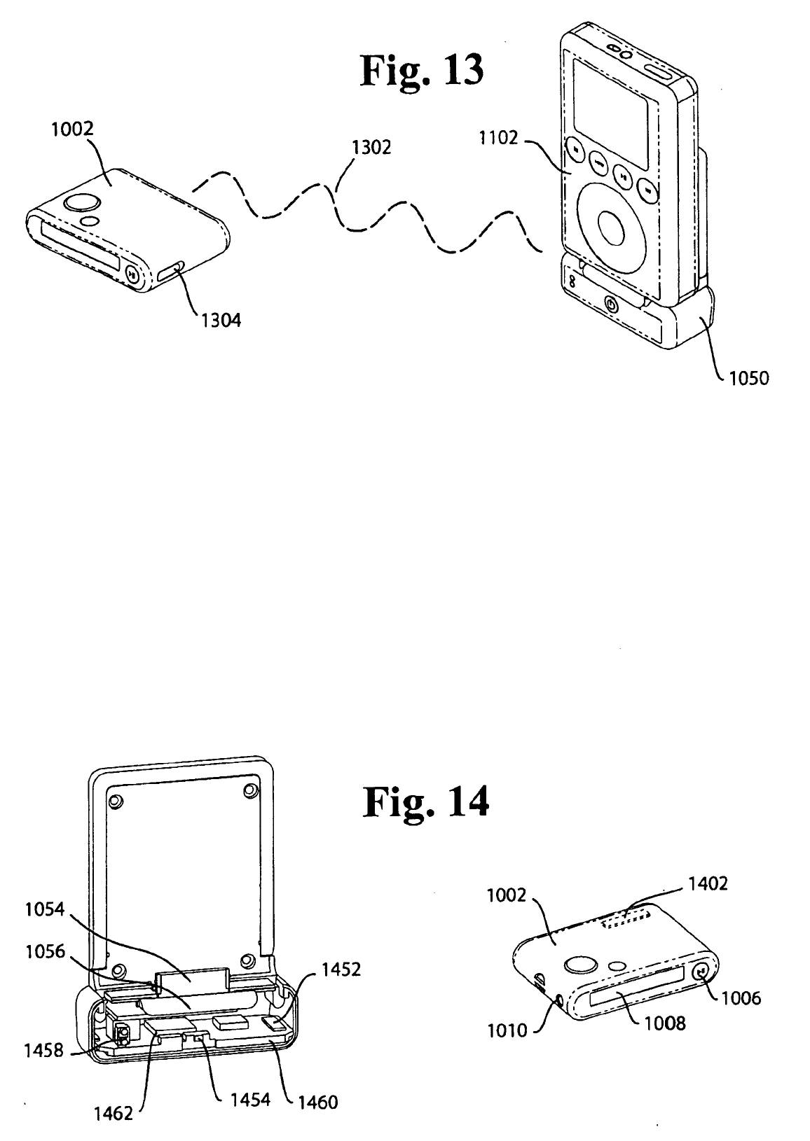

FIG. 10 illustrates a wireless remote control system 1000 configured in accordance with another embodiment of the present invention, including a remote control device 1002 and a base station 1050. Remote control device 1002 includes a multi-way toggle button 1004, a play/pause toggle button 1006, a display 1008, an audio jack 1010, a lanyard attachment 1012, and a menu button 1014. Remote control device 1002 also includes a hold button 1304, as shown in FIG. 13.

In one embodiment, display 1008 is used to display information regarding the status of the audio playback device attached to bas station 1050. For example, display 1008 may show the same information as the display on the audio playback device, but appropriately formatted for the size of display 1008. Thus, where the display displays fewer lines of text or pixels than the display on the audio playback device, display 1008 may scroll through the information provided by the display on the audio playback device, either horizontally or vertically. In another embodiment, display 1008 may display information other than what is displayed on the audio playback device, such as communications link integrity, power levels of the remote control unit, or other relevant information.

Multi-way toggle button 1004 provides for scrolling and selection functions. In one embodiment, multi-way toggle button 1004 is a 4-direction button that also includes a center button. The 4-direction button allow such functional control as volume up/down and track back/forward, while the center button acts as a select or "enter" button. In other embodiments, the functionality of multi-way toggle button 1004 may be provided by one or more separate buttons and switches.

Play/pause toggle button 1006 allows the user to play the selected audio file, or pause the currently playing audio file. Menu button 1014 brings up the menu on display 1008 and also acts as a "back" button to allow for the exit of a particular menu. Hold button 1304 "locks" the controls of remote control device 1304 so that all buttons are disengaged and no inadvertent activation of the buttons will occur.

Lanyard attachment 1012 provides for a loop or keyring holder to be affixed to remote control device 1002 so that remote control device 1002 may be clipped onto a belt or other suitable attachment location on an article of clothing or carrying case.

Audio jack 1010 is a jack that accepts an audio cable for an audio output device as a pair of headphone, speakers, or stereo system components (e.g., pre-amplifiers or amplifiers).

Referring again to FIG. 10, base station 1050 includes a power button 1052, an audio playback device connector/interface 1054, an audio playback device eject/release button 1056, a set of status lights 1058, a battery compartment 1060 and a fold-out support stand 1062. Set of status lights 1058 provides a easy to view the status of the parameters of base station 1050. For example, one of the lights in set of status lights 1058 may indicate that a communications link is established between base station 1050 and the remote control device 1002, while another provides an indication that sufficient battery power exists to operate base station 1050. Further, the same status light may be used to indicate that base station 1050 is "on," as controlled by power button 1052. Further still, the same status light may indicate that base station 1050 is in a "sleep" or "suspended" mode by flashing in a particular pattern.

As shown in FIGs. 12 and 16, a fold-out support stand 1062 folds out from base station 1050 and acts as a stand to allow base station 1050 and the audio playback device to tilt so as to provide a better viewing angle to the user of the display of the audio playback device. Fold-out support stand 1062 may be folded flush with battery compartment 1060 when not in use. Battery compartment 1060 is used to house a user-replaceable rechargeable battery pack.

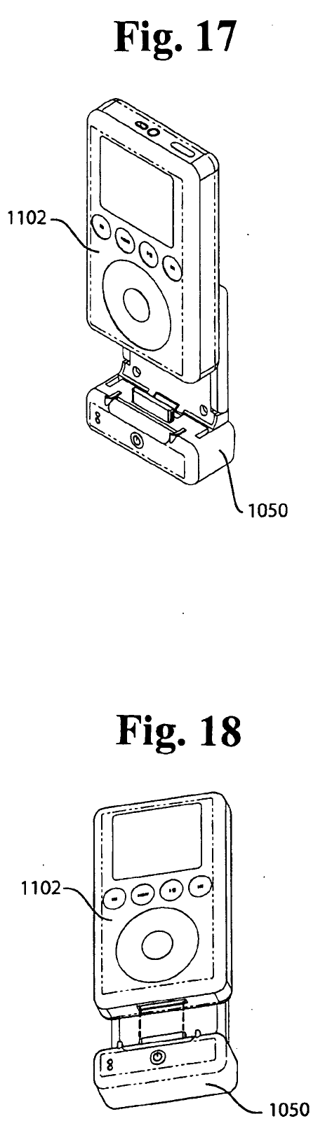

Referring to FIGS. 17 and 18, an audio playback device 1102 is coupled to base station 1050 through an audio playback device connector/interface 1054. As described herein, base station 1050 communicates with audio playback device 1102 through a set of commands provided by the playback device and translates the commands received from remote control device 1002 to one or more commands that are understood by audio playback device 1102. In one embodiment, once audio playback device 1102 is coupled to base station 1050, it may only be ejected using audio playback device eject/release button 1056. Thus, audio playback device 1102 is mechanically engaged with base station 1050, which reduces the likelihood that an accidental disconnection of audio playback device 1102 from audio playback device connector/interface 1054 would occur. In another embodiment, audio playback device eject/release button 1056 is only used to signal base station 1050 that the user desires to disconnect audio playback device 1102 from base station 1050 so that any operations that base station 1050 needs to engage in as part of the disconnection process may be performed. For example, base station 1050 may pause or stop the playback of any audio files and, further, may set audio playback device 1102 to a powered-down or lower-power (e.g., sleep) mode.

FIG. 13 illustrates the communication of a signal 1302 between remote control device 1002 and base station 1050. In one embodiment of the present invention, the communications system between remote control device 1002 and base station 1050 is Bluetooth-based and signal 1302 represents a communications signal conforming to the standard. In another embodiment, the communications system may be wireless Ethernet (e.g., IEEE 802.11). In yet another embodiment, the communications system may be any communication system suitable for the necessary communicated information. For example, a line-of-sight communications system base on technology such as IR may be used, even though the technology does not provide the most robust link, if a constant link does not need to be maintained between the remote control unit and the base station.

In FIG. 14, an antenna 1402 in remote control device 1002 and an antenna 1452 in base station 1050 are shown. Further, FIG. 14 illustrates other internal components of base station 1050, including a power switch 1454 activated by power button 1052 and a light pipe 1458 that provides the light for set of status lights 1058. These components, as well as a processor 1462, are mounted on a circuit bard 1460. In one embodiment, processor 1462 is an application specific integrated circuit (ASIC) designed for the specific processing purposes of the base station. For example, processor 1462 may be a system-on-chip solution provided by Zeevo, Inc. In another embodiment, processor 1462 may be a general purpose processor such as those manufactured by Advanced Micro Devices, Inc. (AMD) or Intel Corporation. Processor 1462 may include an analog-to-digital converter (ADC) as well as a Bluetooth signal encoder.

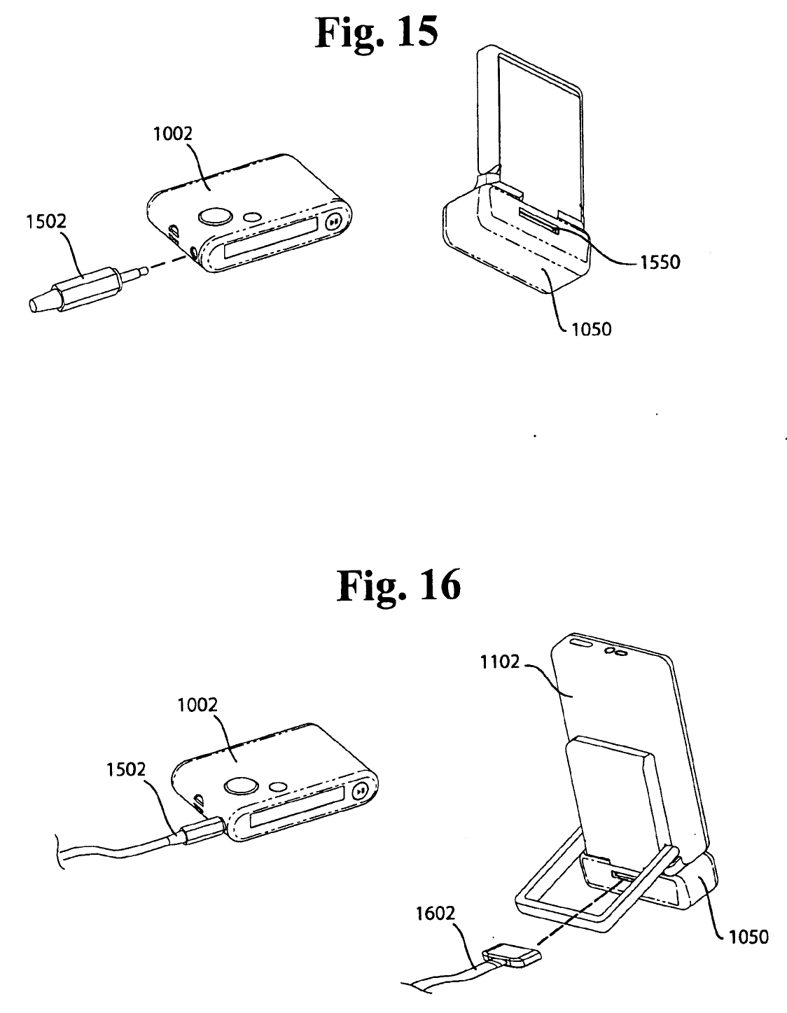

FIGs. 15 and 16 illustrate the coupling of a sound production device plug 1502 from a sound production device such as a speaker or a headphone to remote control device 1002. In addition, a connector 1550 on base station 1050 is used to receive a power/data cable 1602. In one embodiment, power/data cable provides both power to recharge base station 1050 and data connectivity for base station 1050 to a computer. Further, base station may pass through the power to charge audio playback device 1002, as well as selectively pass any data communications to audio playback device 1002. Thus, the computer may contain a software only emulation of remote control device 1002 to control base station 1050, and, in turn, audio playback device 1102.

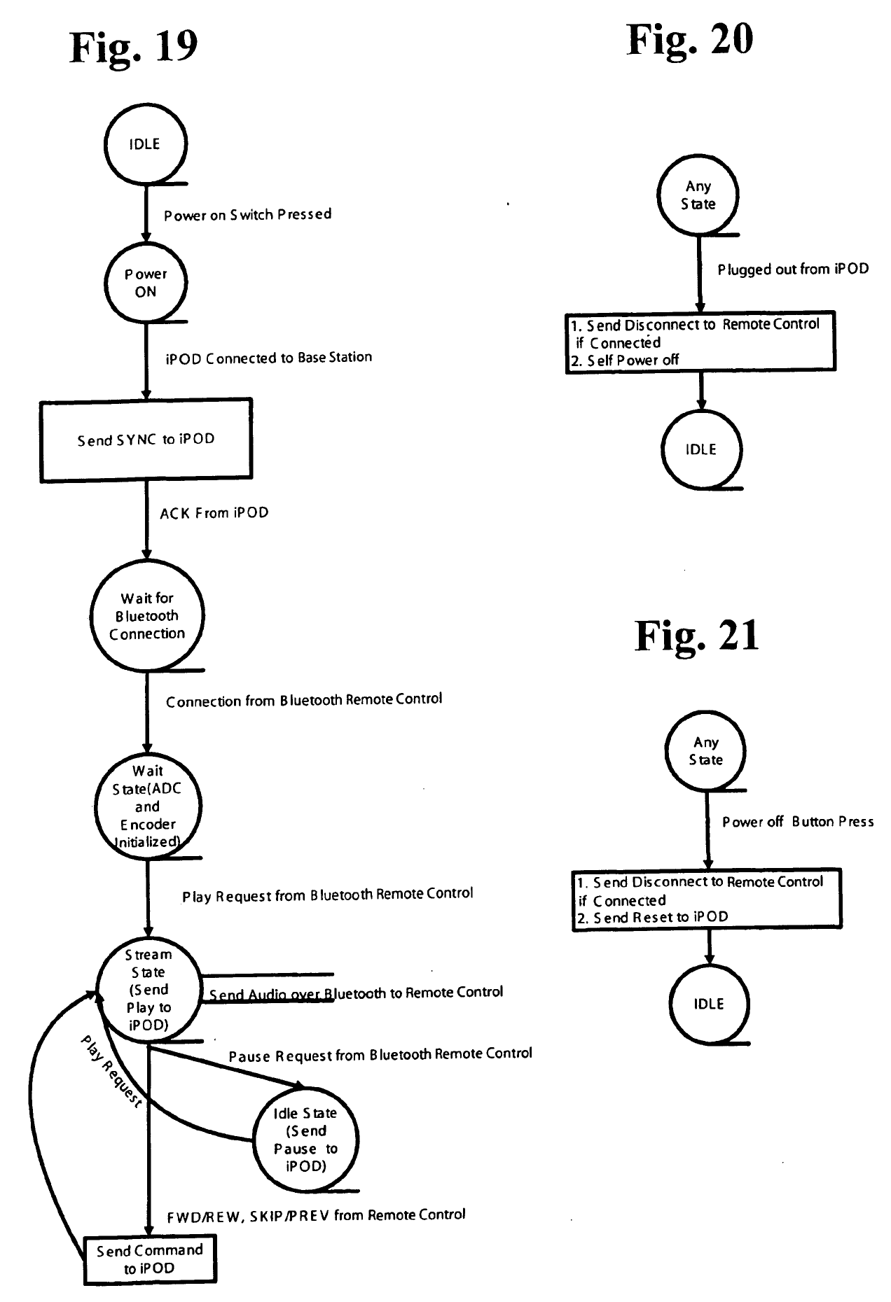

FIGs. 19-21 are state diagrams illustrating the operation of wireless remote control system 1000 in accordance with one embodiment of the present invention where the communications is being performed over Bluetooth. Specifically, FIG. 19 is a state diagram of the operation of base station 1050 where base station 1050 is interfaced with an Apple iPod audio recorder/player as audio playback device 1102 to allow wireless remote control by remote control unit 1002 as a Bluetooth remote control unit. As seen in the figure, base station 1050 operates to set-up the communications "channel" between remote control device 1002 and base station 1050, which allows information from audio playback device 1102 (e.g., information about the audio file being played, information about what audio files are available, etc.) to be transferred to be displayed on remote control device 1002. Base station 1050 also translates any commands received from remote control device 1002 to one or more commands necessary to control audio playback device 1102.

FIG. 20 is a state diagram showing the operation of base station 1050 upon disconnection from audio playback device 1102. For example, base station 1050 may be disconnected by the user using audio playback device eject/release button 1056. FIG. 21 is a state diagram showing the operation of base station 1050 upon receiving a power down signal from a user depressing power button 1052. In another embodiment, the user may use remote control device 1002 to send a power off command to base station 1050, which would accomplish the same result.

The embodiments described above are exemplary embodiments of a the present invention. Those skilled in the art may now make numerous uses of, and departures from, the above-described embodiments without departing from the inventive concepts disclosed herein. Accordingly, the present invention is to be defined solely by the scope of the following claims.

What is Claimed is:

1. A method for providing wireless remote control capability to an audio playback device equipped with wired control capability comprising the steps of:
receiving a wireless signal in a base station coupled to the audio playback device;
decoding the wireless signal; and,
generating a command compatible with the audio playback device based on the wireless signal.

2. The method of claim 1, further comprising the step of transmitting the command to the audio playback device.

3. The method of claim 1, further comprising the step of determining if the wireless signal is a valid signal.

4. The method of claim 3, further comprising the step of advancing a sleep timer if the wireless signal is not a valid signal.

5. The method of claim 1, further comprising the step of configuring the base station to plug into the audio playback device.

6. The method of claim 1, wherein the wireless communication is accomplished through a mode of transmission selected from a group consisting of infrared and radio frequency.

7. The method of claim 6, wherein the radio frequency mode of transmission conforms to a protocol selected from a group consisting of Bluetooth and WiFi.

8. An apparatus for adding wireless remote control to an audio playback device configured to receive a wired controller comprising:
a receiver, the receiver configured to receive a wireless communication;
a processing circuit coupled to the receiver, the processing circuit configured to translate the received wireless communication into a command understood by the audio playback device; and,
a connector configured to couple the circuit to the audio playback device.

9. The apparatus of claim 8, further comprising:
a remote control device including:
a transmitter; and
a display.

10. The apparatus of claim 9, wherein the display indicates the status of the audio playback device.

11. The apparatus of claim 8, wherein the receiver comprises an infrared signal detector.

12. The apparatus of claim 8, wherein the receiver comprises a radio frequency receiver.

13. The apparatus of claim 8, further comprising a base station transmitter.

14. The apparatus of claim 13, wherein the base station transmitter transmits an audio signal.

15. The apparatus of claim 13, wherein the base station transmitter transmits a data signal related to the status of the audio playback device.

16. The apparatus of claim 15, wherein the base station transmitter transmits a control signal to control the remote control device.

17. The method of claim 1, further comprising the step of connecting the base station to the audio playback device using a wired remote connector.

18. The method of claim 1, further comprising the step of connecting the base station to the audio playback device using a docking port.

19. The method of claim 1, further comprising the step of connecting the base station to the audio playback device using a connector configured to carry wired remote signals.

20. The method of claim 1, further comprising the step of transmitting a base station signal from the base station to a remote control unit.

21. The method of claim 22, wherein the base station signal is a control signal.

22. The method of claim 22, wherein the base station signal is a data signal.

23. The method of claim 1, wherein the base station signal is an audio signal.

24. The apparatus of claim 9, where the remote control device includes an audio connector.

25. The apparatus of claim 9, where the remote control device includes a headphone connector.
